(19) United States
(12) Patent Application Publication
(10) Pub. No.: US 2022/0148193 A1
(43) Pub. Date: May 12, 2022

(54) ADAPTIVE OBJECT RECOGNITION APPARATUS AND METHOD IN FIXED CLOSED CIRCUIT TELEVISION EDGE TERMINAL USING NETWORK

(71) Applicant: ELECTRONICS AND TELECOMMUNICATIONS RESEARCH INSTITUTE, Daejeon (KR)

(72) Inventors: Yun Won CHOI, Daegu (KR); Jang Woon BAEK, Daegu (KR); Joon Goo LEE, Daegu (KR); Kil Taek LIM, Daegu (KR)

(73) Assignee: ELECTRONICS AND TELECOMMUNICATIONS RESEARCH INSTITUTE, Daejeon (KR)

(21) Appl. No.: 17/522,469

(22) Filed: Nov. 9, 2021

(30) Foreign Application Priority Data
Nov. 12, 2020 (KR) 10-2020-0150965

(51) Int. Cl. G06T 7/194; G06K 9/62

(52) U.S. Cl. CPC G06T 7/194; G06T 2207/30196; G06K 9/628

(57) ABSTRACT

The present invention is directed to solving the existing problems and provides an apparatus and method for optimizing object detection performance by re-learning data specific to an installed location from an online server using a localization module in an edge terminal receiving a fixed image like a closed circuit television (CCTV) camera.

### CROSS-REFERENCE TO RELATED APPLICATION

This application claims priority to and the benefit of Korean Patent Application No. 10-2020-0150965, filed on Nov. 12, 2020, the disclosure of which is incorporated herein by reference in its entirety.

### BACKGROUND

### 1. Field of the Invention

The present invention relates to an adaptive object recognition apparatus in a fixed closed circuit television edge terminal using a network, and more particularly, to an adaptive object recognition apparatus in a fixed closed circuit television edge terminal using a network for optimizing object recognition performance in an edge terminal receiving an image of an image acquisition device with a fixed location.

### 2. Discussion of Related Art

With the development of deep learning technology, detection performance of objects in closed circuit television (CCTV) images with a fixed installation location is greatly improved, but a deep learning-based object detection technology that has learned general data show performance above a certain level but needs to be optimized for the installation location.

The general optimization method is largely divided into two types. The first is a method for directly re-learning and updating data by a user, and the second is a method of updating data using reinforcement learning technology.

The first method is a method of updating and optimizing weight data by re-learning a database to which a user has added data that marks positions of objects in images obtained from cameras installed in the field, and the second method is a method of automatically updating and optimizing weight data while repeating re-learning based on a pre-designed compensation formula.

Among these methods, the first method has a problem in that it is difficult to optimize a system using CCTV images installed in a plurality of locations since additional tasks of collecting images for a certain period of time installed, generating a database displaying a detection object location, and re-learning the database are continuously generated.

Since the second method continues to perform learning based on a compensation formula in servers connected online, there is a problem in that a high-performance server is required to use a large number of CCTV images, and it is difficult to use the CCTV images in an edge terminal.

Currently, due to the deep learning technology, control centers installed with centralized control systems that collect and analyze CCTV images installed in several locations are increasing nationwide.

However, the deep learning-based edge terminal that analyzes CCTV images based on the conventional online network uses weight data generated by performing learning general database information provided online from the deep learning server, and as a result, has a problem in that a recognition rate is low and a many false detections occur.

In addition, since a user manually updates the weight data learned by reconstructing the database including the data obtained from the edge terminal, there is a limit in optimizing the performance of the deep running-based edge terminal.

Further, the deep learning-based edge terminal that analyzes the CCTV images based on the conventional online network has a problem in that the number of CCTVs that can be processed per deep learning server is inevitably limited, an expensive deep learning server is required to be installed, maintenance cost is high, and a lifetime is greatly shortened due to heat.

### SUMMARY OF THE INVENTION

The present invention is directed to solving the existing problems and provides an apparatus and method for optimizing object detection performance by re-learning data specific to an installed location from an online server using a localization module in an edge terminal receiving a fixed image like a closed circuit television (CCTV) camera.

The objects of the present invention are not limited to the above-described effects. That is, other objects that are not described may be clearly understood by those skilled in the art from the claims.

According to an aspect of the present invention, there is provided an adaptive object recognition apparatus in a fixed CCTV edge terminal using a network, the adaptive object recognition apparatus including an image acquisition unit fixedly installed and configured to acquire image information, a local database configured to store a background removal filter matching external environment information, and a local deep learning detection unit configured to remove a background from an image acquired by the image acquisition unit through the background removal filter and then detect an object from the image acquired by the image acquisition unit based on a weight obtained by performing learning based on an integrated database provided from an online deep learning server.

The external environment information may include at least one of time information, season information, and weather information.

The local deep learning detection unit may collect pieces of object information from the acquired image, classify the pieces of collected object information for each type of object information, and remove the background from the pieces of object information classified for each type of object information by using background filter data matching time or weather information to determine object information (true-positive data) to be preceded and object information (true-negative data) to be removed.

The adaptive object recognition apparatus may include a background removal filter generation unit configured to generate a background removal filter that matches background information of the image information acquired by the image acquisition unit and the external environment information and store the generated background removal filter in the local database.

The adaptive object recognition apparatus may further include an online update unit configured to update object information detected by the local deep learning detection unit to an integrated database of a deep learning server connected through a network.

According to another aspect of the present invention, there is provided an adaptive object recognition method in a fixed CCTV edge terminal using a network, the adaptive object recognition method including: acquiring, by a fixedly installed image acquisition unit, image information; separating, by a local deep learning detection unit, a background from the acquired image information by using a background removal filter corresponding to time information stored in a local database; and detecting, by a local deep learning detection unit, an object from the image information based on a weight acquired using information provided through an integrated database from the image information with a separated background.

In the detecting of the object, the object may be detected based on a weight obtained by performing learning based on an integrated database provided from an online deep learning server.

The adaptive object recognition method may further include matching background information separated from the acquired image information to external environment information while acquiring an image, and storing the matched background information in the local database.

The external environment information may include at least one of the time information, season information, and weather information.

The adaptive object recognition method may further include updating, by an online update unit, object information detected by the local deep learning detection unit to an integrated database of a deep learning server connected through online communication.

The separating of the background from the image may include: collecting, by a deep learning object detection unit, pieces of object information from the acquired image; classifying the pieces of collected object information for each type of object information; removing the background from the pieces of object information classified for each type of object information by using background filter data matching the time information or weather information to remove object information to be preceded (true-positive data) and object information to be removed (true-negative data); and generating the local database using the determined object information (true-positive data) to be preceded and object information (true-negative data) to be removed.

According to an embodiment of the present invention, by receiving an image of a camera and reflecting a background removal filter reflecting local external environment information in object detection in an edge terminal device which is an embedded system level, it is possible to increase a recognition rate of the object and reduce false detection.

The above-described configurations and operations of the present invention will become more apparent from embodiments described in detail below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block configuration diagram for describing an adaptive object recognition apparatus in a fixed closed circuit television (CCTV) edge terminal using a network according to the present invention;

FIG. 2 is a block configuration diagram for describing an object recognition system of a network-based CCTV of FIG. 1;

FIG. 3 is a reference diagram for describing an example of an installation of an edge terminal and image photographing in an embodiment of the present invention;

FIG. 4 is a flowchart for describing an adaptive object recognition method in a fixed CCTV edge terminal using a network according to an embodiment of the present invention;

FIG. 5 is a flowchart for describing detailed operations of a classification operation by object information of FIG. 4;

FIG. 6 is a flowchart for describing a method of updating a local database of an edge terminal according to an embodiment of the present invention;

FIG. 7 is a reference diagram for describing image information photographed by the CCTV of the edge terminal according to the embodiment of the present invention;

FIG. 8 is a reference diagram for describing an example of a background removal filter stored in the local database of the edge terminal according to the embodiment of the present invention; and

FIG. 9 is a reference diagram for describing an object detected in a photographed image using the background removal filter stored in the local database according to the embodiment of the present invention.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to the embodiments disclosed herein but will be implemented in various forms. The embodiments make contents of the present invention thorough and are provided so that those skilled in the art can easily understand the scope of the present invention. Therefore, the present invention will be defined by the scope of the appended claims. Terms used in the present specification are for describing the embodiments rather than limiting the present invention. Unless otherwise stated, a singular form includes a plural form in the present specification. Components, steps, operations, and/or elements described by terms such as “comprise” and/or “comprising” used in the present invention do not exclude the existence or addition of one or more other components, steps, operations, and/or elements.

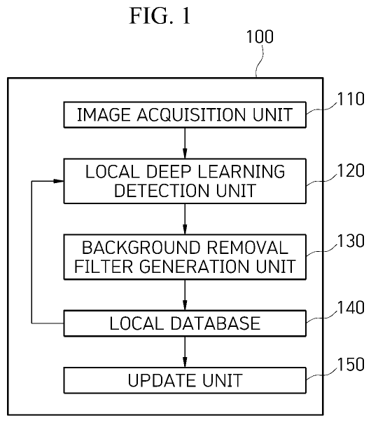

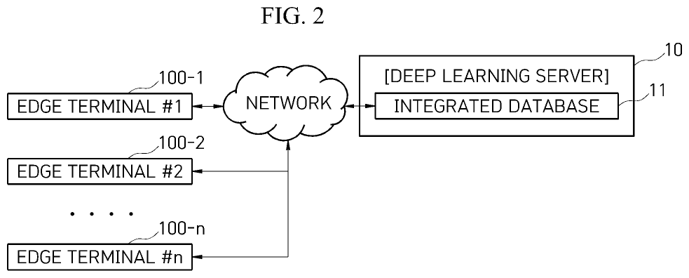

FIG. 1 is a block configuration diagram for describing an adaptive object recognition apparatus in a fixed closed circuit television (CCTV) edge terminal using a network according to the present invention, and FIG. 2 is a block configuration diagram for describing an object recognition system of a network-based CCTV of FIG. 1.

The adaptive object recognition apparatus in a fixed CCTV edge terminal using a network according to the present invention detects objects in CCTV images in each edge terminal device through a deep learning object detection technology by using deep learning information provided through an integrated database of a deep learning server like an object recognition system of a network-based CCTV as illustrated in FIG. 2.

In FIG. 1, the adaptive object recognition apparatus in the fixed CCTV edge terminal using a network according to the embodiment of the present invention includes an image acquisition unit 110, a local database 120, a local deep learning detection unit 130, and a background removal filter generation unit 140.

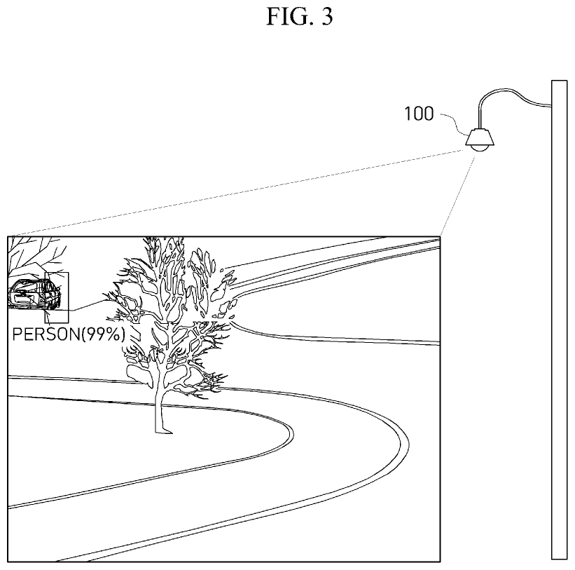

As illustrated in FIG. 3, the image acquisition unit 110 is fixedly installed to acquire image information. In the present embodiment, as illustrated in FIG. 2, since a plurality of edge terminals 100 are installed in different environments, pieces of acquired image information are also different, and the pieces of different image information are photographed according to time, weather, and season.

The local database 120 stores a background removal filter matching external environment information. Here, the external environment information includes at least one of time information, season information, and weather information.

The local deep learning detection unit 130 removes a background from the image acquired by the image acquisition unit 110 through the background removal filter that matches the external environment information.

Thereafter, the local deep learning detection unit 130 detects an object from the image acquired through the image acquisition unit 110 based on a weight obtained by performing learning based on information of an integrated database 11 provided from an online deep learning server 10.

The background removal filter generation unit 140 generates a background removal filter that matches background information excluding object information detected from the image information acquired by the image acquisition unit 110 with the external environment information, and stores the generated background removal filter in the local database 120.

According to an embodiment of the present invention, by receiving an image of a camera and reflecting the background removal filter reflecting local external environment information in object detection in the edge terminal device which is an embedded system level, it is possible to increase a recognition rate of the object and reduce false detection.

According to the embodiment of the present invention, the adaptive object recognition apparatus may further include an update unit 150 that updates the integrated database 11 of the deep learning server 10 accessing the object information detected by the local deep learning detection unit through online communication.

That is, the update unit 150 may remove the background information from the image information by using the background removal filter that matches the external environment information when detecting an object from the acquired image information, detect the object from the image information from which the background has been removed by using the information of the integrated database 11 provided from the online deep learning server 10, and reflect learning information for the object detection in the integrated database 11.

Therefore, according to the embodiment of the present invention, by classifying results recognized by general weight data according to the recognition rate, automatically constructing a high quality specialized local database by reflecting characteristics of the fixed CCTV camera and transmitting the constructed local database to the online server, and providing the weight data re-learned by the deep learning server 10 to the edge terminal again, the adaptive object recognition apparatus may have detection performance more specific to an installation location than the existing method, and thus can be utilized a great deal for the intelligence of the existing CCTV.

That is, the adaptive object recognition apparatus in the fixed CCTV edge terminal using the network according to the embodiment of the present invention is applied to a distributed control system, and a lightweight deep learning model for an embedded system is applied thereto.

That is, as the edge terminal used in the conventional distributed control system is designed to provide the weight data of the deep learning model generally used from the central server to each edge terminal, and perform learning based on a database provided by a central server to show high performance in general situations, the edge terminal has limitations in improving the performance of the object detection, but according to the embodiment of the present invention, it is possible to provide a more accurate object recognition method using the local database suitable for the environment of each edge terminal.

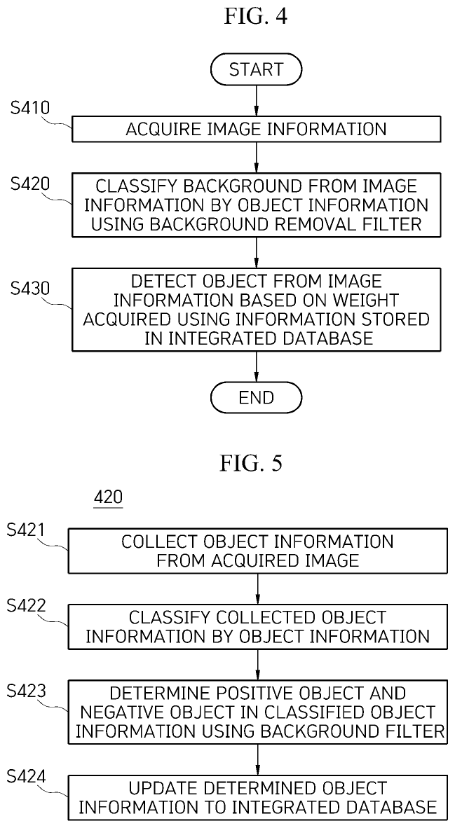

Hereinafter, an adaptive object recognition method in a fixed CCTV edge terminal using a network according to an embodiment of the present invention will be described with reference to FIG. 4.

First, the image information is acquired by the fixedly installed image acquisition unit 110 (S410).

Next, by the local deep learning detection unit 130, the background is separated from the obtained image information by using the background removal filter corresponding to the external environment information when the object information of the image information is detected (S420). That is, in the embodiment of the present invention, the external environment information may include at least one of time information, season information, and weather information. Accordingly, the local deep learning detection unit 130 may have different background removal filters referenced in the local database 120 according to the time, weather, and season for detecting the object.

When the time and weather at the time of the object information detection of the image information are “9 am” (time information) and “sunny” (weather information), the local deep learning detection unit 130 uses a background removal filter corresponding to “9 am” and “sunny weather” in the local database. When weather is rainy, the local deep learning detection unit 130 uses a background removal filter corresponding to “9 am” and “rainy weather”.

Thereafter, the local deep learning detection unit 130 detects an object from the image information through a weight acquired using the information provided through the integrated database 11 in the image information from which the background is separated (S430). In the operation of detecting the object (S430), the object may be detected based on the weight obtained by performing learning based on the integrated database 11 provided from the online deep learning server 10.

FIG. 5 is a flowchart for describing detailed operations of a classification operation by object information of FIG. 4.

As illustrated in FIG. 5, in the operation of separating the background from the image (S420), the object information is collected from the image acquired by the deep learning object detection unit (S421).

Pieces of collected object information are classified for each type of object information (S422). According to the embodiment of the present invention, the classification for each type of object information is made depending on a probability of the object detected by weight data that is generated by learning the integrated database 11 provided from the deep learning server 10.

The classified data is composed of positive data which is object data determined to be greater than or equal to a predetermined probability, negative data which is object data determined to be less than a predetermined probability, and unclassified data which is data that is not determined as an object.

Thereafter, the pieces of object information classified for each type of object information by using the background filter data matching the external environment information composed of the time or weather information is determined to be object information (true-positive data) to be preceded and object information (true-negative data) to be removed (S423).

Then, the object information is updated in the integrated database 11 by using the determined object information (true-positive data) to be preceded and object information (true-negative data) to be removed (S424), and the object information detected by the local deep learning detection unit 130 is updated in the integrated database 11 of the deep learning server 10 connected through the network by the online update unit 150.

Accordingly, the integrated database 11 is transmitted to the deep learning server 10 through the update unit 500 and updates the learned weight data to the edge terminal 100, thereby optimizing the object detection performance.

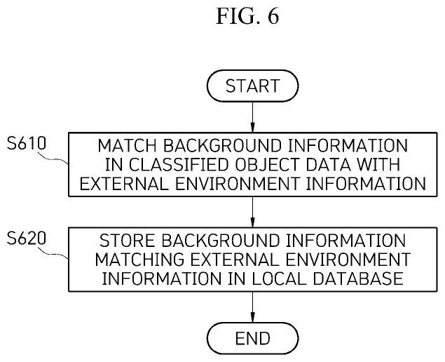

FIG. 6 is a flowchart for describing a method of updating a local database of an edge terminal according to an embodiment of the present invention.

Meanwhile, according to the embodiment of the present invention, when the object information is classified by object information classified in the acquired image information, the background information that is the unclassified data among the classified object information matches the external environment information (S610).

Thereafter, the background information matching the external environment information is stored in the local database 120 (S620).

According to an embodiment of the present invention, it is possible to more accurately detect object information obtained through a deep learning detector by generating the background removal filter that is robust against the surrounding environment using the time information, the weather information, and the season information and databasing the generated background removal filter.

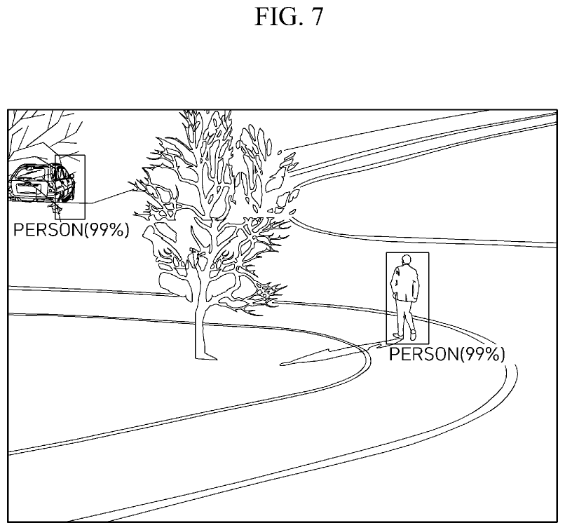

FIG. 7 illustrates the image information acquired through the image acquisition unit 110.

As illustrated in FIG. 7, the local deep learning detection unit 130 may detect two objects in the input image information based on the weight obtained by performing learning based on the integrated database provided from the online deep learning server.

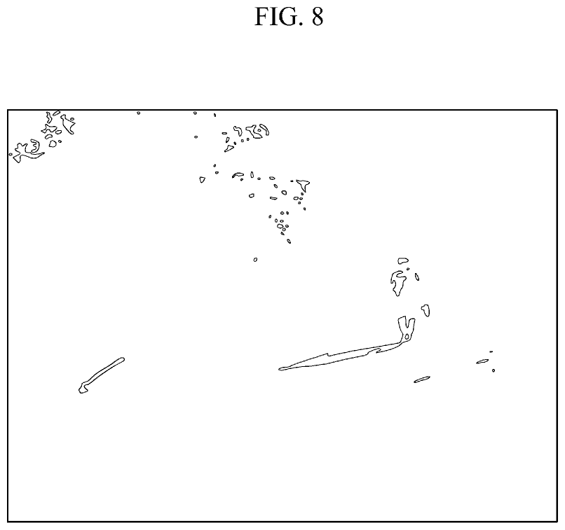

Thereafter, as illustrated in FIG. 8, the local deep learning detection unit 130 removes the background of FIG. 7 through the background removal filter (background image matching the environmental information) matching the environmental information such as the time and weather information of the image information to be detected.

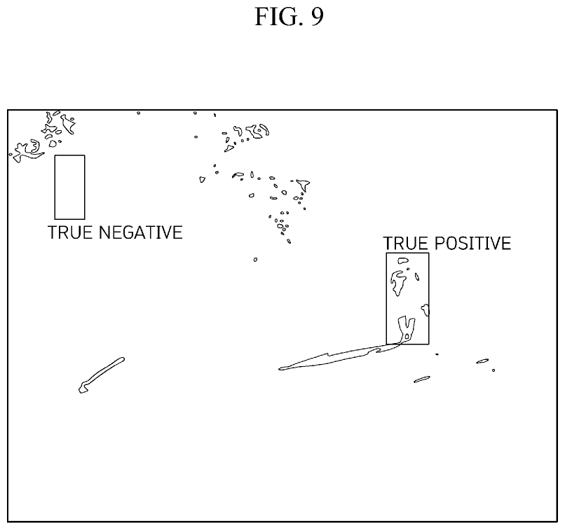

By this process, as illustrated in FIG. 9, one of the detected two objects disappears.

Accordingly, the local deep learning detection unit 130 may determine the disappearing object as a true negative object and determine the remaining objects as a true positive object to accurately recognize the object information.

Accordingly, according to the embodiment of the present invention, it is possible to more accurately distinguish whether the object detected by the deep learning method is information (true negative object) to be excluded or information (true positive object) to be recognized.

Therefore, according to the embodiment of the present invention, when an object such as a person is detected in a conventional image, in the case of classifying the object only through human characteristic information (aspect ratio, minimum size, and recognition probability) through the integrated database, there is an effect of reducing the false detection.

Using this, CCTV images in a fixed location have the effect of securing optimized detection performance at an installation location.

In addition, according to the embodiment of the present invention, by considering the characteristics of the database and the CCTV that always receives a fixed image, it is possible to secure higher performance than the related art by reconstructing a database that is more specialized to the installation location and utilizing the weight data generated by performing re-learning the re-constructed database.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Heretofore, the configuration of the present invention has been described in detail with reference to the accompanying drawings, but this is only an example, and thus, can be variously modified and changed within the scope of the technical idea of the present invention by those skilled in the art to which the present invention belongs. Accordingly, the scope of protection of the present invention should not be limited to the above-described embodiment and should be defined by the description of the claims below.

What is claimed is:

1. An adaptive object recognition apparatus in a fixed closed circuit television edge terminal using a network, the adaptive object recognition apparatus comprising:
an image acquisition unit fixedly installed and configured to acquire image information;
a local database configured to store a background removal filter matching external environment information; and
a local deep learning detection unit configured to remove a background from an image acquired by the image acquisition unit through the background removal filter and then detect an object from the image acquired by the image acquisition unit based on a weight obtained by performing learning based on an integrated database provided from an online deep learning server.

2. The adaptive object recognition apparatus of claim 1, wherein the external environment information includes at least one of time information, season information, and weather information.

3. The adaptive object recognition apparatus of claim 1, wherein the local deep learning detection unit collects pieces of object information from the acquired image, classifies the pieces of collected object information for each type of object information, and removes the background from the pieces of object information classified for each type of object information using background filter data matching time or weather information to determine object information (true-positive data) to be preceded and object information (true-negative data) to be removed.

4. The adaptive object recognition apparatus of claim 3, further comprising a background removal filter generation unit configured to generate a background removal filter that matches background information of the image information acquired by the image acquisition unit with the external environment information and store the generated background removal filter in the local database.

5. The adaptive object recognition apparatus of claim 1, further comprising an online update unit configured to update object information detected by the local deep learning detection unit to an integrated database of a deep learning server connected through a network.

6. An adaptive object recognition method in a fixed closed circuit television edge terminal using a network, the adaptive object recognition method comprising:
acquiring, by a fixedly installed image acquisition unit, image information;
separating, by a local deep learning detection unit, a background from the acquired image information using a background removal filter corresponding to time information stored in a local database; and
detecting, by a local deep learning detection unit, an object from the image information based on a weight acquired using information provided through an integrated database from the image information with a separated background.

7. The adaptive object recognition method of claim 6, wherein, in the detecting of the object, the object is detected based on a weight obtained by performing learning based on an integrated database provided from an online deep learning server.

8. The adaptive object recognition method of claim 6, further comprising:
matching background information separated from the acquired image information to external environment information while acquiring an image; and
storing the matched background information in the local database.

9. The adaptive object recognition method of claim 8, wherein the external environment information includes at least one of the time information, season information, and weather information.

10. The adaptive object recognition method of claim 6, further comprising updating, by an online update unit, object information detected by the local deep learning detection unit to an integrated database of a deep learning server connected through online communication.

11. The adaptive object recognition method of claim 6, wherein the separating of the background from the acquired image information includes:
collecting, by a deep learning object detection unit, pieces of object information from an acquired image;
classifying the pieces of collected object information for each type of object information (positive data, negative data, and unclassified data);
removing the background from the pieces of object information classified for each type of object information using background filter data matching the time information or weather information to remove object information to be preceded (true-positive data) and object information to be removed (true-negative data); and
generating the local database using the determined object information (true-positive data) to be preceded and object information (true-negative data) to be removed.
